(19) United States
(12) Patent Application Publication
(10) Pub. No.: US 2025/0253966 A1
(43) Pub. Date: Aug. 7, 2025

(54) GENERATING CHANNEL FEEDBACK INFORMATION FOR A WIRELESS COMMUNICATIONS SYSTEM

(71) Applicant: Lenovo (United States) Inc., Morrisville, NC (US)

(72) Inventors: Vahid POURAHMADI, München (DE); Vijay NANGIA, WOODBRIDGE, IL (US); Ahmed HINDY, Aurora, IL (US); Venkata Srinivas KOTHAPALLI, Aurora, IL (US); Karthikeyan GANESAN, Nauheim (DE)

(21) Appl. No.: 19/190,334

(22) Filed: Apr. 25, 2025

(51) Int. Cl. H04B 17/391; H04B 7/0417; H04L 5/00

(52) U.S. Cl. CPC H04B 17/3913; H04B 7/0417; H04L 5/0007

(57) ABSTRACT

Various aspects of the present disclosure relate to jointly training two-sided models for a wireless communications system. For example, the wireless communications system may efficiently train and utilize two models (e.g., neural network-based models) when generating channel feedback information and precoding the transmission of signals between a first node and a second node of a network, such as a receiving node and a transmitting node.

### TECHNICAL FIELD

The present disclosure relates to wireless communications, and more specifically to generating channel feedback information for a wireless communications system.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support or implement generating channel feedback information for a wireless communications system.

A first node for wireless communication is described. The first node may be configured to, capable of, or operable to perform one or more operations as described herein. For example, the first node may comprise at least one memory and at least one processor coupled with the at least one memory and configured to cause the first node to receive feedback information associated with a channel condition between the first node and a second node and generated via a neural network (NN)-based channel information encoder at the second node, generate, via an NN-based generator, a first set of symbols based on a set of channel information and multiple input samples, wherein the set of channel information is based on the received feedback information, wherein one or more parameters of the NN-based generator are based on one or more parameters of the NN-based channel information encoder, and one or more parameters of an NN-based detector at the second node that estimates the multiple input samples, and transmit the first set of symbols to the second node.

A method performed or performable by the first node is described. The method may comprise receiving feedback information associated with a channel condition between the first node and a second node and generated via a neural network (NN)-based channel information encoder at the second node, generating, via an NN-based generator, a first set of symbols based on a set of channel information and multiple input samples, wherein the set of channel information is based on the received feedback information, wherein one or more parameters of the NN-based generator are based on one or more parameters of the NN-based channel information encoder, and one or more parameters of an NN-based detector at the second node that estimates the multiple input samples, and transmitting the first set of symbols to the second node.

In some implementations of the first node and method described herein, the first node and method may further be configured to, capable of, performed, performable, or operable to generate a second set of symbols based on the first set of symbols, map the second set of symbols to physical resources, and transmit the second set of symbols to the second node.

In some implementations of the first node and method described herein, the second set of symbols are mapped to multiple time-frequency-antenna ports of the first node.

In some implementations of the first node and method described herein, the first node and method may further be configured to, capable of, performed, performable, or operable to generate the set of channel information based on an NN-based channel information decoder, wherein one or more parameters of the NN-based channel information decoder are determined based on the one or more parameters of the NN-based detector, the one or more parameters of the NN-based channel information encoder, and the one or more parameters of the NN-based generator.

In some implementations of the first node and method described herein, the NN-based detector, the one or more parameters of the NN-based channel information encoder, and the one or more parameters of the NN-based generator are determined by minimizing an average dissimilarity metric between the multiple input samples and an estimation of the multiple input samples.

In some implementations of the first node and method described herein, the dissimilarity metric is based on a mean-square-error or a negative of a cosine-similarity between the multiple input samples and the estimation of the multiple input samples.

In some implementations of the first node and method described herein, the multiple input samples include an uncoded bit stream, an encoded bit stream, or modulated symbols.

In some implementations of the first node and method described herein, to generate the second set of symbols based on the first set of symbols, the first node and method may further be configured to, capable of, performed, performable, or operable to perform orthogonal frequency-division multiplexing (OFDM) with respect to the first set of symbols.

In some implementations of the first node and method described herein, the NN-based generator is associated with multiple input data layers of the first node; and wherein the first set of symbols is associated with multiple transmission antennas of the first node.

In some implementations of the first node and method described herein, the first node and method may further be configured to, capable of, performed, performable, or operable to update the one or more parameters of the NN-based generator based on an update instruction received from a third node.

A second node for wireless communication is described. The second node may be configured to, capable of, or operable to perform one or more operations as described herein. For example, the second node may comprise at least one memory and at least one processor coupled with the at least one memory and configured to cause the second node to receive multiple symbols from a first node, wherein the multiple symbols are associated with time-frequency resources for multiple antennas at the first node and wherein the multiple symbols are based on feedback information and multiple input samples and generated by an NN-based generator at the first node, generate, using an NN-based detector, multiple estimated symbols based on the received multiple symbols, generate an estimated input sample based on the multiple estimated symbols, generate, via an NN-based channel information encoder, the feedback information based on channel condition information between the first node and the second node, and transmit the feedback information to the first node.

A method performed or performable by the second node is described. The method may comprise receiving multiple symbols from a first node, wherein the multiple symbols are associated with time-frequency resources for multiple antennas at the first node and wherein the multiple symbols are based on feedback information and multiple input samples and generated by an NN-based generator at the first node, generating, using an NN-based detector, multiple estimated symbols based on the received multiple symbols, generating an estimated input sample based on the multiple estimated symbols, generating, via an NN-based channel information encoder, the feedback information based on channel condition information between the first node and the second node, and transmitting the feedback information to the first node.

In some implementations of the second node and method described herein, one or more parameters of the NN-based detector are determined jointly with one or more parameters of the NN-based channel information encoder and one or more parameters of the NN-based generator at the first node.

In some implementations of the second node and method described herein, the multiple symbols are a distortion of symbols transmitted by the first node and based on channel conditions between the first node and the second node.

In some implementations of the second node and method described herein, the channel condition information is determined based on reference signals received from the first node or the received multiple symbols.

In some implementations of the second node and method described herein, a single NN-block contains the NN-based detector and the NN-based channel information encoder and generates the estimated input sample and the feedback information.

In some implementations of the second node and method described herein, the second node and method may further be configured to, capable of, performed, performable, or operable to input, to the NN-based channel information encoder, information identifying one or more previous channel condition information between the first node and the second node.

In some implementations of the second node and method described herein, the parameters for the NN-based detector, the NN-based channel information encoder, and the NN-based generator are determined by minimizing an average dissimilarity between the multiple input samples and the estimated input sample.

In some implementations of the second node and method described herein, the parameters for the NN-based detector, the NN-based channel information encoder, and the NN-based generator are determined by minimizing an average of mutual information between the feedback information and the channel condition information.

### BRIEF DESCRIPTION OF THE DRAWINGS

FIG. 1 illustrates an example of a wireless communications system in accordance with aspects of the present disclosure.

FIG. 2 illustrates example blocks of a transmitting and receiving chain in accordance with aspects of the present disclosure.

FIG. 3 illustrates example blocks of an NN-based CSI-feedback module in accordance with aspects of the present disclosure.

FIGS. 4A-4B illustrate example blocks of a joint NN-based Rx-Tx chain and CSI-feedback module in accordance with aspects of the present disclosure.

FIG. 5 illustrates example blocks of an encoder module in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE or an NE in accordance with aspects of the present disclosure.

FIG. 10 illustrates a flowchart of a method performed by a UE or an NE in accordance with aspects of the present disclosure.

### DETAILED DESCRIPTION

The present disclosure relates to methods, apparatuses, and systems that provide, support, implement, and/or introduce the generation of feedback information (e.g., CSI feedback information) for a wireless communications system that employs NN-based methods for enhancing the exchange of channel information between an NE and one or more UEs. For example, the NE may directly measure the channel (e.g., represented as Hₗ^{k}(t) at time t over frequency l, l={1, 2, . . . , L}) and/or the UE may indirectly measure the channel (and provide the measurements (e.g., CSI) to the NE).

The measurement of the channel may be complex, such as in cases where there are a large number of antennas and/or frequency bands. A UE, in order to send complete information regarding the channel (H^{k}), may transmit information about N×M×L complex numbers (e.g., where the H^{k} is defined as a matrix of size N×M×L). Such transmissions may be inefficient and/or require significant resources.

The wireless communications system may utilize NN-based methods for reducing the rate or exchange of feedback information between UEs and NEs. For example, the wireless communications system may develop and/or deploy two-sided models, such as NN-based models where a first part is deployed at the UE side and a second part is deployed at the NE side. For example, the UE side may include an encoder part or module and generate a latent representation of input data (e.g., the channel data to be sent to the NE) with a low number of bits. The NE side, being a decoder part or module, receives the latent representation and reconstructs the channel data.

In some cases, the two-sided model is trained such that an output of the decoder is as close as possible to its expected output (e.g., the raw channel measurements, or eigenvectors associated with a measured channel). Thus, the encoder and decoder may form an autoencoder that has an output matching its input (or as close as possible to its input). Once trains, the NE, or decoder) uses its output (e.g., the channel data) to determine a best precoder matrix (e.g., vector) for transmission of signals, to improve the throughput/spectral efficiency of the transmitted signal.

The UE, as the transmitter (Tx), may utilize an NN block to construct the symbols (e.g., latent representation) to be sent to the NE. Similarly, the NE, as the receiver (Rx), utilizes an NN block, to recover the channel information from the received symbols. In such cases, the Tx NN block and the Rx NN block are trained jointly or together, as the two blocks are part of one two-sided model.

Thus, there may be two (or multiple) two-sided models—a first model (e.g., an encoder-decoder model), which is associated with the transmission of feedback data between the UE and the NE, and a second model (e.g., the NN blocks), which is associated with the transmission of data (signaling) between the UE and the NE. Typically, the two models may be separately trained, where the first model is trained to align an output of the decoder to its expected output, while the second mode is trained to maximize the throughput/spectral efficiency of a communication link (between the UE and NE).

However, the two models are inter-related, because the NN block of the transmitter (e.g., the Tx NN block) may use an output of the decoder of the first model to determine the transmission symbols (e.g., the precoder) of the second model. The technology described herein facilitates the joint training of the two models, enabling the reduction/compression of transmitted channel data (e.g., feedback rate of CSI) while maintaining information that is useful for precoding. Thus, jointly training the two-sided models may facilitate the compression of feedback data and minimization of information that is transmitted for Tx symbol generation (e.g., during precoding). The wireless communications system, therefore, may efficiently train and utilize the two models when generating feedback information and precoding the transmission of signals between NEs and UEs, among other benefits.

Aspects of the present disclosure are described in the context of a wireless communications system.

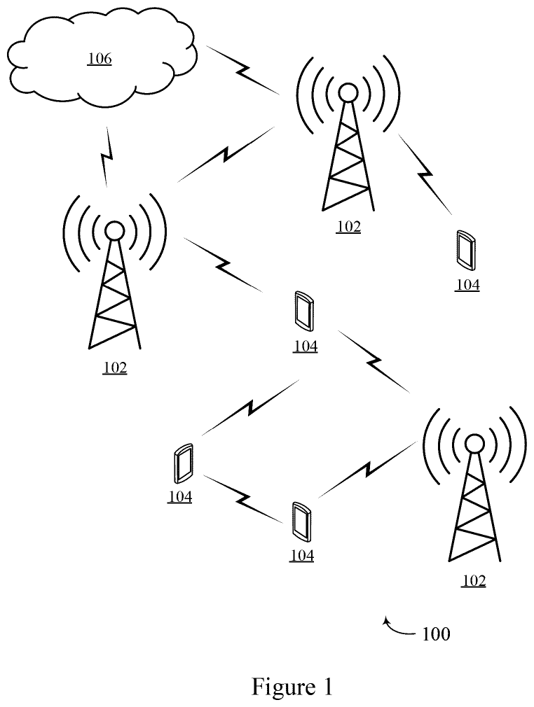

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D 2D) communication link. In some implementations, such as vehicle-to-vehicle (V2V) deployments, vehicle-to-everything (V 2X) deployments, or cellular-V 2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 KHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHZ-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 KHz subcarrier spacing; and a fourth numerology (e.g., μ=3), which includes 120 KHz subcarrier spacing.

As described herein, the technology provides for the use and deployment of artificial intelligence/machine learning (AI/ML) models (e.g., NNs) within various entitles, such as UEs, base stations (e.g., gNBs), and so on. For example, the two-sided models, which employ NN blocks, may be deployed within single user scenarios as well as multi-user scenarios, such as by NEs and/or UEs that implement multiple-input multiple-output (MIMO) configurations (e.g., multi-user MIMO (MU-MIMO) antenna configurations).

As an example, a transmitter, or Tx, equipped with M antennas, transmits to or communicates with a receiver, or Rx, equipped with N antennas, where each communication may include [symbol] series of bits ( [symbol] layers). The Tx may include an NN based Tx block (or NN based generator), which receives input in the form of bits or symbols and generates output signals corresponding to different Tx antennas. The bits (e.g., coded or uncoded input bits) received by the Tx may pass through an NN-based module, which generates symbols for each of the M antennas of the Tx.

As an example, the Tx may employ an orthogonal frequency-division multiplexing (OFDM) scheme with a Resource Block (RB) size of K subcarriers and S OFDM symbols. A resource element (RE) may then be a single OFDM symbol and a subcarrier that can carry a modulation symbol. The number of REs in one RB is then equal to K×S. Thus, for M antennas, where each antenna carries K×S symbols for each RB, the total number of REs (and equivalently symbols transmitted on them) is M×K×S. From the REs of each antenna, some REs may be reserved for other tasks (e.g., reference symbol transmissions), where J REs are available for data transmission.

The NN-based module of the Tx may generate symbols γ_{b}[i]∈C^{M} for a RB b, where i={1, 2, . . . , J}, where γ_{b}[i] is a vector with M complex numbers (one for each of the M antennas) associated to the i-th RE of the b-th RB (and where all available REs are the same in all antennas). In some cases, such as when one antenna (e.g., m₁) has a pre-set value (e.g., not generated from the input data) for a particular RE (e.g., i₁) the value on the corresponding element of γ_{b}, e.g., γ_{b}[i₁][m₁]=preset value.

In some cases, the input to the NN-based module may be symbols that correspond to the input data bits. For example, the input bits may be passed through a channel encoder and then changed to modulation symbols using various modulation schemes. The output of the NN-based module is symbols associated with each of the M antennas and generated based on the input symbols. For multi-layer deployments, the input data may be based on the input bits of multiple layers.

Without channel information at the Tx, the NN-based module may determine the model parameters for a mapping function between the input and the output symbols, based on an average receiver experiencing different channel conditions. However, if some CSI (e.g., at least a partial CSI, such as a delayed CSI), some representation of CSI, or some feedback information representative of a channel condition, is available at the Tx, the performance of the link may be improved when the NN-block receives the CSI-related information as input data (e.g., as part of input data).

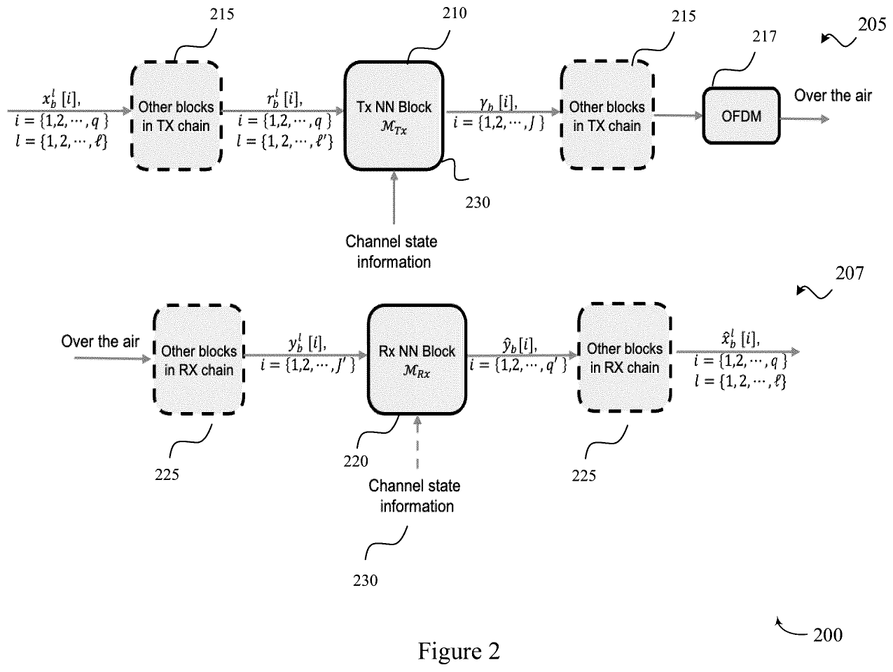

FIG. 2 illustrates example blocks of a transmitting and receiving chain 200 in accordance with aspects of the present disclosure. The chain 200 includes a Tx 205 having a Tx NN block 210 (e.g., [symbol] _{Tx}), such as an NN-based generator, and other Tx blocks 215. The chain 200 also includes an Rx 207 having an Rx NN block 220 (e.g., [symbol] _{Rx}), or NN-based detector, and other Rx blocks 225.

The Tx 205 receives x_{b}^{l}[i] as input bits for different layers and for each RB. The input bits are passed through various Tx blocks 215, such as a channel encoder, modulator, and so on, before proceeding to the Tx NN block 210 ( [symbol] _{Tx}), or NN-based generator. The [symbol] _{Tx} may also observe one input as side information related to the channel state, or channel condition (e.g., CSI 230) and generates γ_{b}[i]. The γ_{b}[i] passes through various Tx blocks 215 (e.g., RE mapping (e.g., symbols of different layers mapped to different antenna ports (or other physical resources), such as multiple time-frequency-antenna ports), OFDM blocks 217, digital/analog (D/A) converters, radio frequency (RF) chain, and so on, before being transmitted over the air (e.g., using a transmit antenna array comprising antenna elements associated with the M antenna ports).

In some cases, the [symbol] _{Tx} may perform the tasks associated with the various Tx blocks 215, and thus, the Tx 205 may only include the [symbol] _{Tx}, which may also act as a precoder block, may map the symbols of different layers to different antenna ports (or other physical resources), such as multiple time-frequency-antenna ports, may perform both modulation and antenna mapping, and so on.

The Rx 207 receives the signal (e.g., over the air), which may then pass through various Rx blocks 225 (e.g., RF chain, A/D converters, cyclic prefix (CP) removal or equalizations, and so on) before being input into the Rx NN block 220 ( [symbol] _{Rx}), or NN-based detector. The [symbol] _{Rx} generates \hat{γ}_{b}[i]. The [symbol] _{Rx} may also observe, as one input, the information related to the channel state or channel condition (e.g., the CSI 230). The output of the [symbol] _{Rx} may pass through a few other Rx blocks 225 (e.g., a channel decoder) before the RX 207 generates a final output, \hat{x}_{b}^{l}[i]. The \hat{x}_{b}^{l}[i] represents an estimation by the Rx 207 for each of the input bits for the different layers and for each RB (e.g., x_{b}^{l}[i]).

In some cases, the [symbol] _{Rx} may perform the tasks associated with the various Rx blocks 225, and thus, the Rx 207 may only include the [symbol] _{Rx}, which may also act to detect of soft values for each of the transmitted bits from demodulated symbols, may perform demodulation and channel equalizations, and so on.

In some cases, the training of the [symbol] _{Tx} and [symbol] _{Rx} may be based on minimizing a loss function, such as a loss function based on an average dissimilarity between \hat{x}_{b}^{l}[i] and x_{b}^{l}[i].

In some examples, a CSI feedback module may be enhanced or otherwise updated to function as a side information module, a positioning feedback module, a UE feedback module, or various combinations, as described herein. For example, an over the air signal may be based on a Tx (e.g., the Tx 205) and/or channel conditions during the transmission. In some cases, if the Tx 205 is aware of channel conditions prior to transmission (e.g., using previous CSI) the Tx 205 may mitigate channel distortions (via pre-compensation techniques).

For example, the CSI 230 input to the [symbol] _{Tx} may represent the (partial) knowledge of channel state information (e.g., channel condition information) gained by the Tx 205, and the Tx 205 may utilize the CSI 230 when determine the transmit symbols. Also, the [symbol] _{Rx} may use the CSI 230 during the detection of the transmitted signal. In some cases, the CSI 230 received by the [symbol] _{Tx} may be different than the CSI 230 received by the [symbol] _{Rx}, since the [symbol] _{Rx} may use newly measured CSI, whereas the CSI received by the [symbol] _{Tx} may reflect channel conditions measured at a previous time.

As described herein, the Tx 205 and/or the Rx 207 may include another NN-based model or module, such as an NN-based encoder (e.g., an [symbol] ₑ) or NN-based decoder (e.g., an [symbol] _{d}). For example, the Rx 207 may include an [symbol] ₑ (e.g., a long short-term memory (LSTM)-NN model). The Me receives CSI or other channel information (e.g., from current or previous states of the channel) and generates, using the [symbol] _{d}, an output that may be employed during construction (or generation) of the CSI 230 input into the [symbol] _{Tx} (e.g., in FIG. 2).

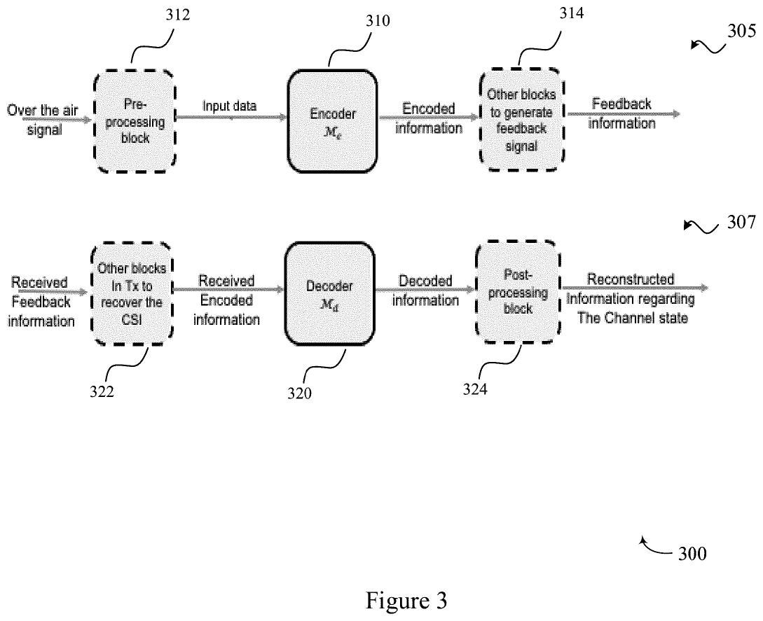

FIG. 3 illustrates example blocks of an NN-based CSI-feedback module 300 in accordance with aspects of the present disclosure. An Rx 305 receives an over the air signal via a pre-processing block 312, which generates input data for an Rx encoder 310 (e.g., the encoder model [symbol] ₑ) For example, the pre-processing block 312 may be a channel estimator block that estimates the channel state (e.g., channel condition) based on the received signal or based on the receive reference symbols (RSS), mat determine a representation associated with the channel (e.g., one or more eigenvectors of the estimated channel), and so on.

In some cases, the input data may be based on the received symbols, such as after OFDM demultiplexing. For example, the Rx 305 uses the generated information to construct the input and generate the encoded information, where the input data has a that is short enough to reduce transmission overhead while conveying enough information used by a Tx 307 when generating transmit symbols. In some cases, the encoded information may pass through other Rx blocks 314 blocks to generate actual feedback information (e.g., channel encoding, RE mapping, OFDM blocks), and so on. As described herein, in some cases, the Rx 305 may only include the [symbol] ₑ, which then performs any pre-processing or information generation.

The Tx 307 receives the signal (e.g., feedback information) via one or more Tx blocks 322, such as blocks that perform CP removal, equalizations, channel decoding, and so on, to construct the received encoded information. A Tx decoder 320 (e.g., the encoder, [symbol] _{d}) generates the decoded information based on the received encoded information. The decoded information may then pass through a post-processing block 324 to generate final reconstructed information regarding the channel state (e.g., channel condition). As described herein, in some cases, the Tx 307 may only include the [symbol] _{d}, which then performs any construction, processing, and so on.

In some cases, the received feedback information may also experience some distortion based on the channel. As described herein, the Rx 305 may utilize the feedback channel when determining the encoded information (e.g., resulting in more reliable feedback information). Further, in some cases,

In some cases, the training of the [symbol] ₑ and [symbol] _{d} may be based on minimizing a loss function, such as a loss function based on an average dissimilarity between the decoded information after [symbol] _{d} and the input data of the [symbol] ₑ (e.g., based on a mean-square-error or a negative of a cosine-similarity between multiple input samples and the estimation of multiple input samples or a constant (e.g., 1)-cosine-similarity between multiple input samples and the estimation of multiple input samples). The loss function may be based on an average dissimilarity between the final reconstructed information and the input data of the [symbol] ₑ. The Tx 307 may then use the final reconstructed information to determine a channel information input (e.g., CSI 230) of [symbol] _{Tx}.

In some examples, the NN-based modules of the Tx-Rx chain (e.g., as depicted in FIG. 2) and the NN-based modules of the CSI feedback module (e.g., as depicted in FIG. 3) may be jointly trained (e.g., trained together or with respect to one another). As described herein, a joint training procedure may reduce feedback overhead, facilitate encoding of relevant information, reduce implementation complexities for the models, and other benefits.

To jointly train both NN-based models, the loss function of the CSI feedback module may be changed or modified. For example, instead of training the encoder and decoder NN blocks to generate outputs similar to a pre-determined expected output, the CSI input (e.g., CSI 230) of the [symbol] _{Tx} of Tx 205 is fed the output of the CSI feedback module (e.g., the output of the Tx 307) as its input. Thus, the NN-blocks of the CSI-feedback module and Tx-Rx chain are jointly trained.

In some examples, to train at least one of the NN-based modules of the Tx-Rx chain, a transmitter power constraint may be included in the loss function. For example, the loss function may include a term than penalizes when the average output power exceeds a threshold, such as a loss function term max

$$( 0 , \frac{1}{j} {\sum }_{j} {‖ {x}_{j} ‖}^{2} - P ) ,$$

which imposes an average power constraint on the j-samples (denoted as xi) of the output of the Tx NN block 210 or the other Tx blocks 215. The term penalizes the NN-based model parameters when the average power of the samples is larger than some constant P (e.g., P=1). In some cases, the number of samples j may be sufficiently large to have a good representation of the average power.

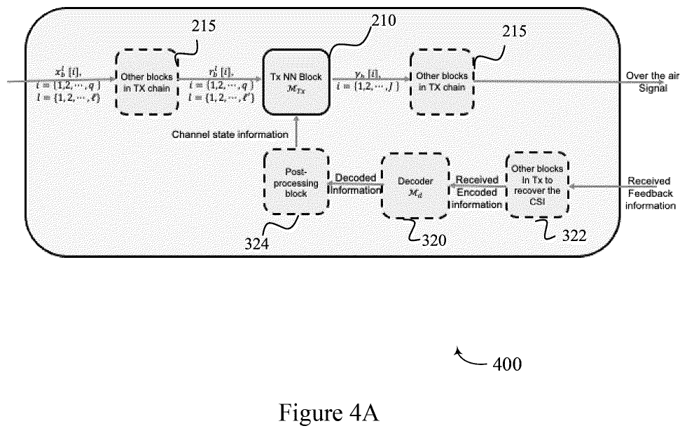

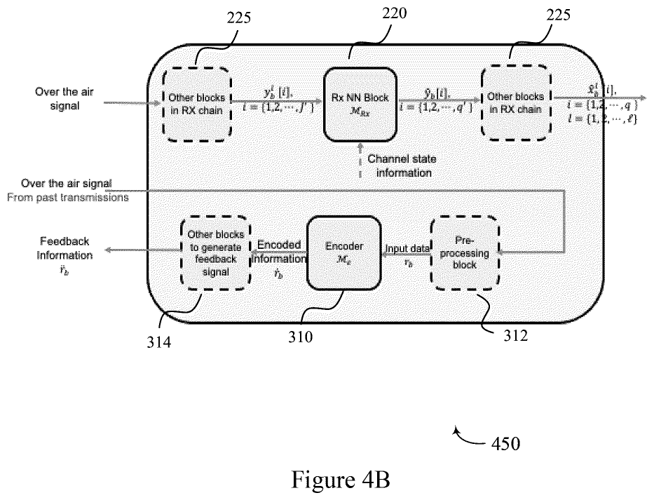

FIGS. 4A-4B illustrate example blocks of a joint NN-based Rx-Tx chain and CSI feedback module in accordance with aspects of the present disclosure. FIG. 4A depicts a Tx 400 for the joint NN-based Rx-Tx chain and CSI feedback module. As shown, the Tx 400 combines the elements of the Tx 205 and the Tx 307, where the [symbol] _{Tx} (e.g., the Tx NN block 210) receives CSI from the Tx encoder [symbol] _{d} (via the one or more post-processing blocks 324).

In some cases, the post-processing block 324 may perform the various functions, as described herein, and/or may receive input from the feedback data of multiple receivers (UEs) and generate the CSI input for multiple [symbol] _{Tx} modules.

In some cases, the Tx 400 may not include the [symbol] _{d}. Instead, the [symbol] ₑ generates the feedback data for use by the [symbol] _{Tx}. Thus, the [symbol] _{Tx} may include aspects of the [symbol] _{d}, reducing the complexity of the Tx 400.

FIG. 4B depicts an Rx 450 for the joint NN-based Rx-Tx chain and CSI feedback module. As shown, the RX 450 combines the elements of the Rx 207 and the Rx 305, where the [symbol] _{Rx} (e.g., the Rx NN block 220 or NN-based detector) receives CSI from the Rx encoder [symbol] ₑ and may output feedback information via the encoder [symbol] ₑ.

In some cases, the CSI input to the [symbol] _{Tx}, at time t, may be generated from already received feedback information (e.g., feedback information generated at the Rx 450) at a time before time t (e.g., from past transmissions within the over the air signal received in previous time slots). For example, in a first time slot where the Tx 400 does not have any feedback information, the Tx 400 may use a default value as the CSI input of [symbol] _{Tx}. As another example, the Tx 400 may send some signals (e.g., RSs), to the Rx 450, and the Rx 450 estimates the channel and feeds the estimate as input into the [symbol] _{Rx}, which encodes the CSI and generates feedback to send to the Tx 400. The Tx 400 uses the feedback information in subsequent transmission to transmit the actual data bits.

In some cases, instead of having a complete loop for the over the air signal to the input of the [symbol] ₑ, the [symbol] ₑ may be based on the channel state (e.g., the channel condition information) and not the actual data for that time slot. The Rx 450 may estimate the channel state (e.g., the channel condition information) and then feed the estimation to the [symbol] _{Rx}. In such cases, the pre-processing block 312 may perform the various functions, as described herein, and/or some portion of the input and/or output of the [symbol] _{Rx} corresponding to the current time slot and/or previous time slots may be fed to the pre-processing block 312 and/or the encoder [symbol] ₑ (e.g., instead of the over the air signals).

In some cases, the [symbol] ₑ and [symbol] _{Rx} may be jointly implemented. Thus, the Rx 450 may include a single NN-block that receives inputs based on some parts of the over the air signal and generates two outputs, where one output represents \hat{γ}_{b}[i] and the other output is the encoded information (for the feedback data).

As described herein, the loss function may be based on minimizing an average dissimilarity between \hat{x}_{b}^{l}[i] and x_{b}^{l}[i]. During the training phase, the two-sided model observes several instances of symbols generated based on the input data (e.g., x_{b}^{l}[i]), which are distorted with different realizations of a channel. The channel realization can be different from one sample to another sample. To model the practical settings, the model is jointly trained, and the channel realization between consecutive samples is not independent (or the CSI feedback information may not contain information regarding the channel in a next time slot). An example loss function may be defined as loss₁=average dis(\hat{x}_{b}^{l}[i],x_{b}^{l}[i]), where dis(a,b) is a function (determined in each implementation) showing a dissimilarity between

$${\hat{x}}_{b}^{l} [ i ] and {x}_{b}^{l} [ i ] , e . g . , dis ( a , b ) = {norm}_{2} ( a - b ) or dis ( a , b ) = - \frac{{a}^{T} b}{{‖ a ‖}_{2} {‖ b ‖}_{2}} ,$$

Where modeling of the channel and modeling channel variations in different time slots may be based on the implementation of the model and/or be decided on a case-by-case basis; and
where the dissimilarity between \hat{x}_{b}^{l}[i] and x_{b}^{l}[i] for different selections of a) x_{b}^{l}[i], b) a channel (received over the air signal) at the current time slot, (e.g., H[t₁]) and/or c) a channel (received over the air signal) at previous time slots (e.g., H[t<t₁]) may depend on the model parameters of all NN-based blocks [symbol] _{Tx}, [symbol] _{Rx}, [symbol] ₑ, and [symbol] _{d} (if they exist). The optimal model parameters may be determined by a gradual modification of the model parameters to minimize the average loss function.

In some cases, such as to further optimize or enhance a designed/trained model, a loss function may include another term that penalizes models with larger feedback sizes. Thus, when the CSI feedback module attempts to convey as much information as possible regarding the channel to a Tx, the module to attempt to compress the information as much as possible and avoid sending information that is not useful for determining transmit symbols.

As one example, the loss function may have another term proportional to the mutual information between the encoded data (\dot{r}_{b}(output of [symbol] ₑ) and the input data of [symbol] ₑ, where loss₂=I(\dot{r}_{b},r_{b}).

As another example, instead of the output of [symbol] ₑ, the loss function may be based on the mutual information between the input data of [symbol] ₑ and the output of [symbol] ₑ (e.g., with some extra processing such as quantization), and/or between input data of [symbol] ₑ and the feedback information (\ddot{r}_{b}), where loss₂=I(\ddot{r}_{b},r_{b}).

As another example (e.g., such as when [symbol] ₑ and [symbol] _{Rx} is in one NN-block), the loss function may have a term that is proportional to the entropy of the encoded data, \dot{r}_{b} (e.g., the output of [symbol] ₑ) and/or the feedback data (after passing through other blocks), where loss₂=H(\dot{r}_{b}) or loss₂=H(\ddot{r}_{b}).

In some cases, minimizing the mutual information or entropy may enable the encoder to reduce the size of the encoded information, as there is not much information needed to be fed back (e.g., the information may be sent with fewer bits) and reduce the overhead. However, such a loss function may seem counter intuitive, since minimizing the mutual information between the encoded data (e.g., the output of [symbol] ₑ) and the input data of [symbol] ₑ may realize no information about the input data (e.g., the channel information is available at the encoded data) exist in the feedback information.

A saddle point, however, is that the loss function has the other part regarding the dissimilarity between \hat{x}_{b}^{l}[i] and x_{b}^{l}[i]. Thus, the model attempts to generate the best transmit symbols, where the Rx 450 can generate xy [i] that are as close as possible to x_{b}^{l}[i]. The Tx 400, therefore, uses the feedback information sent back from the Rx 450, although using more feedback information may increase the loss function (due to the second part of the loss function). During joint training, the combined two-sided model learns a balance point between the mutual information part (e.g., the feedback overhead) and the dissimilarity part (e.g., the accuracy of data detection).

In some cases, the loss function enables the training of the CSI feedback module as a task oriented NN block. For example, the trained CSI feedback may then reconstruct the input data to the CSI feedback module (e.g., the autoencoder procedure used training of the CSI feedback modules). Instead, the [symbol] ₑ only attempts to encode data useful for the Tx-Rx chain.

Further, the feedback rate may be adapted based on a current state. For example, when a UE observes that a channel state (e.g., channel condition) is changing very quickly and the feedback information is outdated when received by the Tx 400, the UE does not send the feedback information (e.g., due to fewer feedback transmissions). For example, minimization of the mutual information (or entropy) represents that less information is sent as feedback to a receiving node. In some cases, less mutual information or entropy may not lead to a smaller number of feedback bits, because the number of feedback bits may remain unchanged (e.g., even when the information sent is reduced).

Thus, if [symbol] ₑ can optimize the mutual information by changing the number of feedback bits, the number of feedback bits may be effectively reduced. The structure of [symbol] ₑ may be determined to minimize the loss₂ (e.g., by reducing the number of feedback bits).

In some examples, adding a mask generator block to the [symbol] ₑ enables adjustment of the number of neurons to be transmitted. For example, a mask generator block may be based on input data or based on other factors (e.g., the signal-to-noise radio (SNR) of the link, an amount of feedback cost, and so on). For example, when the mask generator input data is based on the input data, the encoder model may adapt its feedback rate based on the complexity of input data (e.g., where the input data depends on the received over the air signal or the state of the channel between the Tx 400 and the Rx 450).

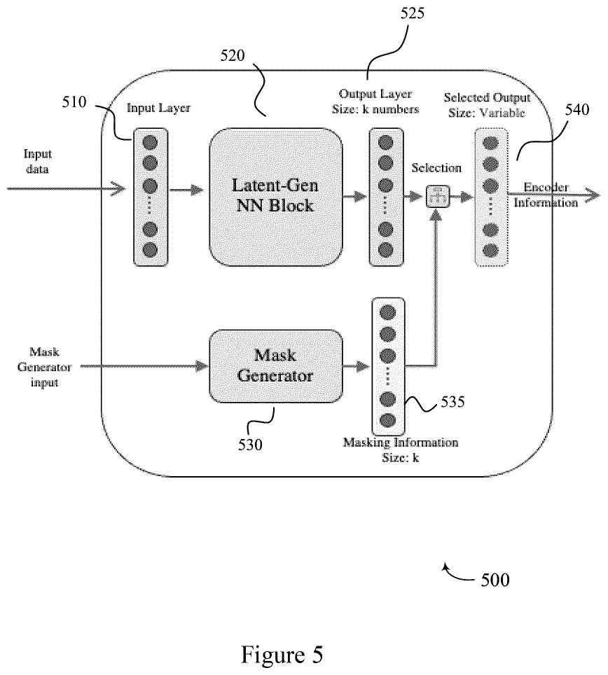

FIG. 5 illustrates example blocks of an encoder module 500 in accordance with aspects of the present disclosure. The encoder module 500 (e.g., which may be the [symbol] ₑ) may receive input data via an input layer 510 at a Latent-Gen NN-block 520. An output layer 525 may have an output size of k numbers.

A mask generator 530 receives a mask generator input. The encoder module 500 may search over different parameters of the mask generator 530, (jointly with the Latent-Gen NN-block 520, which results in a different number of active neurons. A masking information layer may output masking information of size k. An output selection module 540 receives the output layer size and the masking information size and selects an output size for outputted encoder information. For example, a fewer number of active neurons may reduce the second part of the loss function, loss₂ while increasing the loss₁. Thus, the NN block parameters may be gradually determined or updated by finding a balance between the first and second parts of the loss function.

In some examples, the NN blocks may be retrained or fine-tuned based on variations over the other blocks of the Tx 400 and/or the Rx 450. For example, a change in a state of the other blocks of the Tx 400 may initiate a first indication signaling from the Tx 400 to the Rx 450. As another example, a change in a state of the other blocks in the Rx 450 may initiate a second indication signaling from the Rx 450 to the Tx 400 within a feedback signal. The first indication signaling, the second indication signaling, or both, may correspond to a transmission configuration indicator (TCI) state signaling, a signaling associated with reporting a change in additional conditions to the Tx 400 or to the Rx 450, respectively, and so on.

For example, an NN block of the Tx 400 and the Rx 450 may be associated with computing a precoding filter, a receive filter in one of a physical downlink shared channel (PDSCH) or physical uplink shared channel (PUSCH) signal, where associated feedback information corresponds to a compressed version of CSI, a predicted version of CSI associated with a future time slot with respect to a time slot in which the feedback information is generated, or some combination. As another example, the NN block of the Tx 400 may be associated with computing or selecting a modulation scheme associated with a transmit constellation corresponding to a transmitted signal. As another example, the NN blocks may be associated with positioning-related reference signal transmission and measurement, respectively, where feedback information corresponds to a function of auxiliary positioning information.

In some cases, the parameters of the NN-based generator may be based on an update instruction received from a third node, such as another NE 102 or UE 104.

In some cases, channel quality information, including quantized values of measured signal-to-interference and noise ratio (SINR) at the Rx 450 ensures the selection of an appropriate modulation and coding scheme (MCS) to achieve a target block error rate (e.g., around 10% or 1%), based on a reliability requirement of a traffic characteristic. The encoder model may select a compression ratio according to the reporting quantity, for example, for different reporting quantities (e.g., such as a cri-RI-PMI-CQI, cri-RI-LI-PMI-CQI, cri-RI-i1, cri-RI-i1-CQI, cri-RI-CQI, cri-RSRP, ssb-index-RSRP, cri-SINR, ssb-index-SINR, and so on), where the compression ratio methodology may be separately defined. Also, the compression ratio may be differently set for each of the CSI (e.g., a channel quality indicator (CQI), a precoding matrix indicator (PMI), a CSI-RS resource indicator (CRI), SS/PBCH block resource indicator (SSBR1), LI, RI, L1-RSRP, and so on) depending on the channel condition and quality of feedback used by the Tx 400.

In some cases, such as for a non-AI/ML system, the SINR values may be quantized, and the quantized SINR may be reported as part of the CSI. However, with the AI/ML framework, a high resolution of SINR may be reported with no quantization and/or with quantization with a separate compression ratio for the NN model to assist the AI/ML assisted MCS selection at the Tx 400. The compression ratio may be set according to the channel condition or the acknowledgement (ACK)/NACK error ratio. For example, the compression ratio can be set to low when hybrid automatic repeat request (HARQ)-NACKS are higher and set to high when the HARQ-ACKs ratio is greater. In some cases, when the channel condition is good (e.g., when the UE is in a good geometry, the SINR is high, and/or HARQ-ACKs are received) the Tx 400 may select a non-quadrature amplitude modulation (QAM) modulation scheme to boost the channel capacity. However, when the UE is not in a good geometry, the Tx 400 may select a fallback with the QAM modulation.

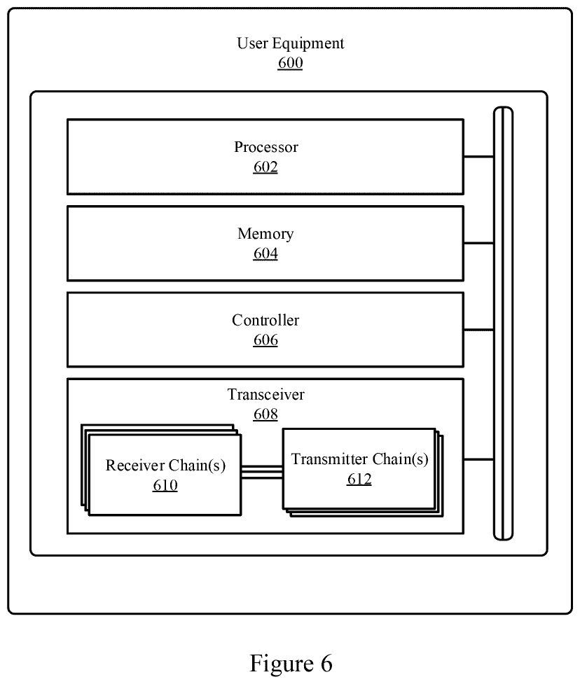

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 802 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 802 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for receiving feedback information associated with a channel condition between the first node and a second node and generated via an NN-based channel information encoder at the second node, generating, via an NN-based generator, a first set of symbols based on a set of channel information and multiple input samples, wherein the set of channel information is based on the received feedback information, wherein one or more parameters of the NN-based generator are based on: one or more parameters of the NN-based channel information encoder, and one or more parameters of an NN-based detector at the second node that estimates the multiple input samples; and transmitting the first set of symbols to the second node.

As another example, the processor 602 may support wireless communication at the UE 600 in accordance with examples as disclosed herein. The UE 600 may be configured to support a means for receiving multiple symbols from a first node, wherein the multiple symbols are associated with time-frequency resources for multiple antennas at the first node and wherein the multiple symbols are based on feedback information and multiple input samples and generated by an NN-based generator at the first node, generating, using an NN-based detector, multiple estimated symbols based on the received multiple symbols; generating an estimated input sample based on the multiple estimated symbols, generating, via an NN-based channel information encoder, the feedback information based on channel condition information between the first node and the second node, and transmitting the feedback information to the first node.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 802.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

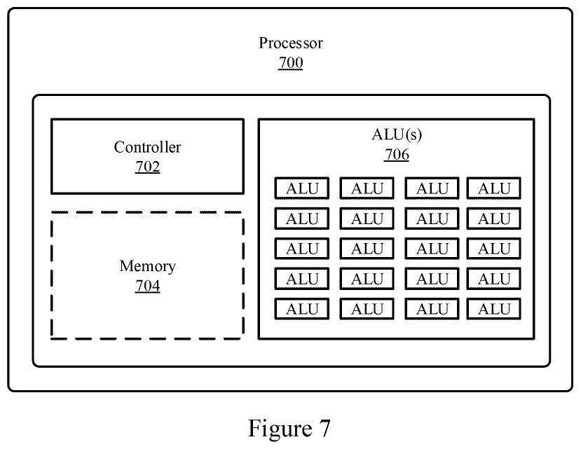

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means for receiving feedback information associated with a channel condition between the first node and a second node and generated via an NN-based channel information encoder at the second node, generating, via an NN-based generator, a first set of symbols based on a set of channel information and multiple input samples, wherein the set of channel information is based on the received feedback information, wherein one or more parameters of the NN-based generator are based on: one or more parameters of the NN-based channel information encoder, and one or more parameters of an NN-based detector at the second node that estimates the multiple input samples; and transmitting the first set of symbols to the second node.

As another example, the processor 700 may be configured to or operable to support a means for receiving multiple symbols from a first node, wherein the multiple symbols are associated with time-frequency resources for multiple antennas at the first node and wherein the multiple symbols are based on feedback information and multiple input samples and generated by an NN-based generator at the first node, generating, using an NN-based detector, multiple estimated symbols based on the received multiple symbols; generating an estimated input sample based on the multiple estimated symbols, generating, via an NN-based channel information encoder, the feedback information based on channel condition information between the first node and the second node, and transmitting the feedback information to the first node.

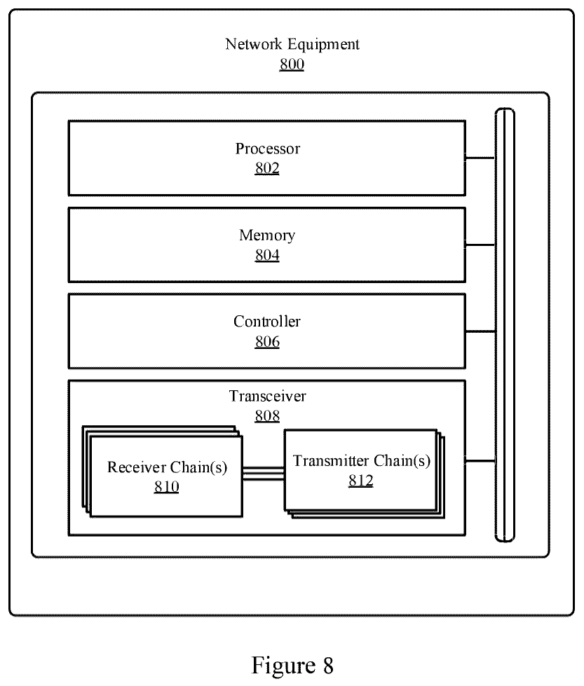

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for receiving feedback information associated with a channel condition between the first node and a second node and generated via an NN-based channel information encoder at the second node, generating, via an NN-based generator, a first set of symbols based on a set of channel information and multiple input samples, wherein the set of channel information is based on the received feedback information, wherein one or more parameters of the NN-based generator are based on: one or more parameters of the NN-based channel information encoder, and one or more parameters of an NN-based detector at the second node that estimates the multiple input samples; and transmitting the first set of symbols to the second node.

As another example, the NE 800 may be configured to support a means for receiving multiple symbols from a first node, wherein the multiple symbols are associated with time-frequency resources for multiple antennas at the first node and wherein the multiple symbols are based on feedback information and multiple input samples and generated by an NN-based generator at the first node, generating, using an NN-based detector, multiple estimated symbols based on the received multiple symbols; generating an estimated input sample based on the multiple estimated symbols, generating, via an NN-based channel information encoder, the feedback information based on channel condition information between the first node and the second node, and transmitting the feedback information to the first node.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

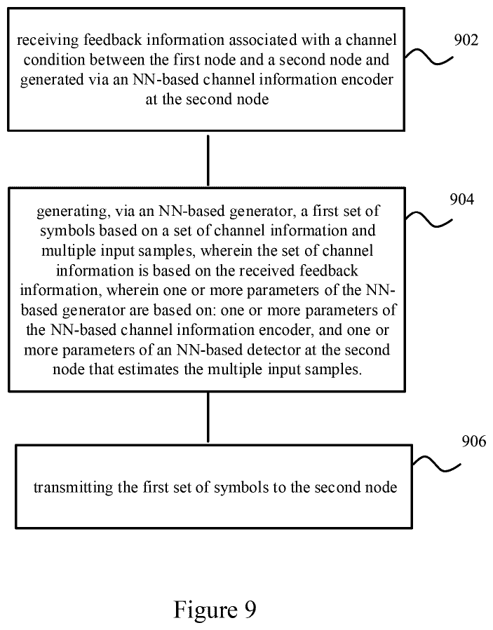

FIG. 9 illustrates a flowchart of a method in accordance with aspects of the present disclosure. The operations of the method may be implemented by a UE or an NE (e.g., as a first node) as described herein. In some implementations, the UE or the NE may execute a set of instructions to control the function elements of the UE or NE to perform the described functions.

At 902, the method may include receiving feedback information associated with a channel condition between the first node and a second node and generated via an NN-based channel information encoder at the second node. The operations of 902 may be performed in accordance with examples as described herein. In some implementations, aspects of the operations of 902 may be performed by a UE or an NE as described with reference to FIG. 6 or FIG. 8.

At 904, the method may include generating, via an NN-based generator, a first set of symbols based on a set of channel information and multiple input samples, wherein the set of channel information is based on the received feedback information, wherein one or more parameters of the NN-based generator are based on: one or more parameters of the NN-based channel information encoder, and one or more parameters of an NN-based detector at the second node that estimates the multiple input samples. The operations of 904 may be performed in accordance with examples as described herein. In some implementations, aspects of the operations of 904 may be performed a UE or an NE as described with reference to FIG. 6 or FIG. 8.

At 906, the method may include transmitting the first set of symbols to the second node. The operations of 906 may be performed in accordance with examples as described herein. In some implementations, aspects of the operations of 906 may be performed a UE or an NE as described with reference to FIG. 6 or FIG. 8.

It should be noted that the method described herein describes a possible implementation, and that the operations and the steps may be rearranged or otherwise modified and that other implementations are possible.

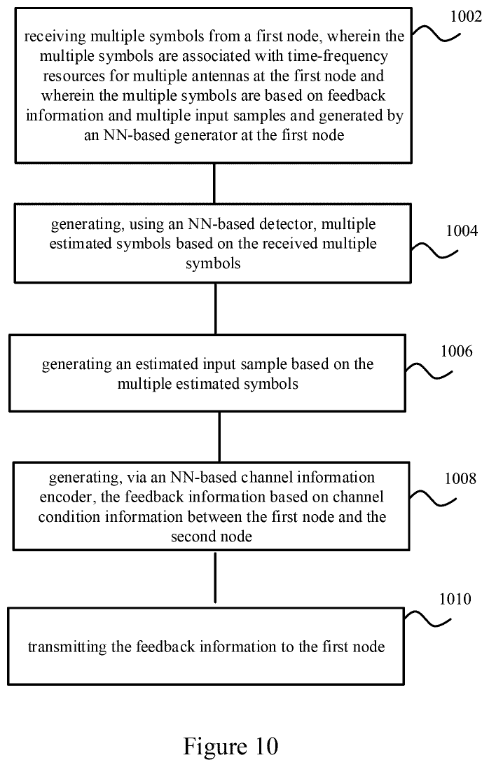

FIG. 10 illustrates a flowchart of a method in accordance with aspects of the present disclosure. The operations of the method may be implemented by an NE or a UE (e.g., as a second node) as described herein. In some implementations, the NE or the UE may execute a set of instructions to control the function elements of the NE or the UE to perform the described functions.

At 1002, the method may include receiving multiple symbols from a first node, wherein the multiple symbols are associated with time-frequency resources for multiple antennas at the first node and wherein the multiple symbols are based on feedback information and multiple input samples and generated by an NN-based generator at the first node. The operations of 1002 may be performed in accordance with examples as described herein. In some implementations, aspects of the operations of 1002 may be performed by a UE or an NE as described with reference to FIG. 6 or FIG. 8.

At 1004, the method may include generating, using an NN-based detector, multiple estimated symbols based on the received multiple symbols. The operations of 1004 may be performed in accordance with examples as described herein. In some implementations, aspects of the operations of 1004 may be performed by a UE or an NE as described with reference to FIG. 6 or FIG. 8.

At 1006, the method may include generating an estimated input sample based on the multiple estimated symbols. The operations of 1006 may be performed in accordance with examples as described herein. In some implementations, aspects of the operations of 1006 may be performed by a UE or an NE as described with reference to FIG. 6 or FIG. 8.

At 1008, the method may include generating, via an NN-based channel information encoder, the feedback information based on channel condition information between the first node and the second node. In some implementations, aspects of the operations of 1008 may be performed by a UE or an NE as described with reference to FIG. 6 or FIG. 8.

At 1010, the method may include transmitting the feedback information to the first node. The operations of 1010 may be performed in accordance with examples as described herein. In some implementations, aspects of the operations of 1010 may be performed by a UE or an NE as described with reference to FIG. 6 or FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first node for wireless communication, comprising:
at least one memory; and
at least one processor coupled with the at least one memory and configured to cause the first node to:
receive feedback information associated with a channel condition between the first node and a second node and generated via a neural network (NN)-based channel information encoder at the second node;
generate, via an NN-based generator, a first set of symbols based on a set of channel information and multiple input samples, wherein the set of channel information is based on the received feedback information,
wherein one or more parameters of the NN-based generator are based on:
one or more parameters of the NN-based channel information encoder, and
one or more parameters of an NN-based detector at the second node that estimates the multiple input samples; and
transmit the first set of symbols to the second node.

2. The first node of claim 1, wherein the at least one processor is further configured to cause the first node to:
generate a second set of symbols based on the first set of symbols;
map the second set of symbols to physical resources; and
transmit the second set of symbols to the second node.

3. The first node of claim 2, wherein the second set of symbols are mapped to multiple time-frequency-antenna ports of the first node.

4. The first node of claim 1, wherein the at least one processor is configured to cause the first node to generate the set of channel information based on an NN-based channel information decoder, wherein one or more parameters of the NN-based channel information decoder are determined based on the one or more parameters of the NN-based detector, the one or more parameters of the NN-based channel information encoder, and the one or more parameters of the NN-based generator.

5. The first node of claim 1, wherein the one or more parameters of the NN-based detector, the one or more parameters of the NN-based channel information encoder, and the one or more parameters of the NN-based generator are determined by minimizing an average dissimilarity metric between the multiple input samples and an estimation of the multiple input samples.

6. The first node of claim 5, wherein the dissimilarity metric is based on a mean-square-error or a negative of a cosine-similarity between the multiple input samples and the estimation of the multiple input samples.

7. The first node of claim 1, wherein the multiple input samples include an uncoded bit stream, an encoded bit stream, or modulated symbols.

8. The first node of claim 1, wherein, to generate the second set of symbols based on the first set of symbols, the at least one processor is configured to cause the first node to perform orthogonal frequency-division multiplexing (OFDM) with respect to the first set of symbols.

9. The first node of claim 1, wherein the NN-based generator is associated with multiple input data layers of the first node; and wherein the first set of symbols is associated with multiple transmission antennas of the first node.

10. The first node of claim 1, wherein the at least one processor is further configured to cause the first node to:
update the one or more parameters of the NN-based generator based on an update instruction received from a third node.

11. A second node for wireless communication, comprising:
at least one memory; and
at least one processor coupled with the at least one memory and configured to cause the second node to:
receive multiple symbols from a first node,
wherein the multiple symbols are associated with time-frequency resources for multiple antennas at the first node and
wherein the multiple symbols are based on feedback information and multiple input samples and generated by a neural network (NN)-based generator at the first node;
generate, using an NN-based detector, multiple estimated symbols based on the received multiple symbols;
generate an estimated input sample based on the multiple estimated symbols;
generate, via an NN-based channel information encoder, the feedback information based on channel condition information between the first node and the second node; and
transmit the feedback information to the first node.

12. The second node of claim 11, wherein one or more parameters of the NN-based detector are determined jointly with one or more parameters of the NN-based channel information encoder and one or more parameters of the NN-based generator at the first node.

13. The second node of claim 11, wherein the multiple symbols are a distortion of symbols transmitted by the first node and based on channel conditions between the first node and the second node.

14. The second node of claim 11, wherein the channel condition information is determined based on reference signals received from the first node or the received multiple symbols.

15. The second node of claim 11, wherein a single NN-block contains the NN-based detector and the NN-based channel information encoder and generates the estimated input sample and the feedback information.

16. The second node of claim 11, wherein the at least one processor is further configured to cause the second node to input, to the NN-based channel information encoder, information identifying one or more previous channel condition information between the first node and the second node.

17. The second node of claim 11, wherein the parameters for the NN-based detector, the NN-based channel information encoder, and the NN-based generator are determined by minimizing an average dissimilarity between the multiple input samples and the estimated input sample.

18. The second node of claim 11, wherein the parameters for the NN-based detector, the NN-based channel information encoder, and the NN-based generator are determined by minimizing an average of mutual information between the feedback information and the channel condition information.

19. A method performed by a first node, the method comprising:
receiving feedback information associated with a channel condition between the first node and a second node and generated via a neural network (NN)-based channel information encoder at the second node;
generating, via an NN-based generator, a first set of symbols based on a set of channel information and multiple input samples, wherein the set of channel information is based on the received feedback information,
wherein one or more parameters of the NN-based generator are based on:
one or more parameters of the NN-based channel information encoder, and
one or more parameters of an NN-based detector at the second node that estimates the multiple input samples; and
transmitting the first set of symbols to the second node.

20. A method performed by a second node, the method comprising:
receiving multiple symbols from a first node,
wherein the multiple symbols are associated with time-frequency resources for multiple antennas at the first node and
wherein the multiple symbols are based on feedback information and multiple input samples and generated by a neural network (NN)-based generator at the first node;
generating, using an NN-based detector, multiple estimated symbols based on the received multiple symbols;
generating an estimated input sample based on the multiple estimated symbols;
generating, via an NN-based channel information encoder, the feedback information based on channel condition information between the first node and the second node; and
transmitting the feedback information to the first node.
